(19) United States
(12) Patent Application Publication
(10) Pub. No.: US 2015/0002579 A1
(43) Pub. Date: Jan. 1, 2015

(54) INK-JET RECORDING APPARATUS WITH RECOVERY MECHANISM OF RECORDING HEAD

(71) Applicant: KYOCERA Document Solutions Inc., Osaka (JP)

(72) Inventor: Yasutaka INUI, Osaka (JP)

(21) Appl. No.: 14/309,258

(22) Filed: Jun. 19, 2014

(30) Foreign Application Priority Data
Jun. 28, 2013 (JP) 2013-136605

(51) Int. Cl. B41J 2/165

(52) U.S. Cl. CPC B41J 2/16535
USPC 347/33

(57) ABSTRACT

A recovery system for a recording head includes a recording head, a wiper, an application member, a driving mechanism, and a control unit for controlling the operation of the application member and the at least one wiper. The recording head includes a nozzle region where a discharge nozzle has an opening. The nozzle region is configured to discharge ink onto a recording medium. The wiper is in pressure contact with a wiping start position outside the nozzle region to wipe an ink discharge face in a predetermined direction. The ink discharge face includes the nozzle region. The application member is configured to apply ink discharged from the nozzle region over the ink discharge face. The driving mechanism is configured to reciprocate the wiper along the ink discharge face and to move the wiper in an approaching or separating direction with respect to the ink discharge face.

### CROSS-REFERENCE TO RELATED APPLICATIONS

This application is based upon, and claims the benefit of priority from, corresponding Japanese Patent Application No. 2013-136605, filed in the Japan Patent Office on Jun. 28, 2013, the entire contents of which are incorporated herein by reference.

### BACKGROUND OF THE INVENTION

Unless otherwise indicated herein, the description in this section is not prior art to the claims in this application and is not admitted to be prior art by inclusion in this section.

A recording apparatus such as a facsimile, a copier, and a printer is constituted so as to record an image to a recording medium such as a paper and an OHP sheet. The recording apparatus can be classified into an ink jet type, a wire dot type, a thermal type, or a similar type depending on a recording method. An ink jet recording method is classified into a serial type and a line head type. The serial type performs recording by scanning a recording head on a recording medium. The line head type performs recording with the recording head secured to an apparatus main body.

An ink-jet recording apparatus of line head type includes line head type inkjet heads (recording heads) for respective colors. The inkjet heads each have discharge nozzles. The discharge nozzles align at predetermined intervals across a whole print region width perpendicular to a conveyance direction of a recording medium. The ink-jet recording apparatus of line head type discharges ink from the discharge nozzles corresponding to a printing position in synchronization with a conveyance of the recording medium, thus ensuring printing on the whole recording medium.

This ink-jet recording apparatus may cause deterioration of straightness of ink (flying curve), discharge failure, or a similar failure due to deterioration of printing performance of the recording head. This occurs probably due to generation of an abnormal meniscus. The abnormal meniscus is caused by: a foreign object such as paper powder, dust, and dirt generated during conveyance of a paper sheet, a minute ink droplet (hereinafter referred to as mist), which is discharged together with ink droplet for image recording or mist bounced when the ink droplet attaches the recording medium, being attached to the ink discharge face of the recording head. The probable causes of the failure are also: reduction in sealability when mounting a cap due to drying of the mist attached to the cap mounted portion, and an increase of viscosity of the ink in the nozzle in association with the deterioration of sealing performance.

Therefore, to prevent drying of ink in the ink discharge nozzles that have openings at the ink discharge face of recording head or clogging of the nozzle due to increased viscosity of ink inside of the ink discharge nozzle, the following constitution that performs a recovery process is employed. The constitution forcibly discharges (purges) ink from the nozzle, the ink attached to the ink discharge face (nozzle face) is wiped off with a blade-shaped wiper, thus performing a recovery process of the recording head. However, with only simple purge operation and wiping operation, it is difficult to completely remove ink whose viscosity has been increased and dried mist. In particular, the more a solid constituent that the ink contains, the more the viscosity of ink tends to increase. Accordingly, wiping off the ink with the wiper becomes difficult.

Therefore, methods for efficiently removing ink attached to the ink discharge face have been variously proposed. For example, the following inkjet head cleaning apparatus is known. The cleaning apparatus includes a suction nozzle. The suction nozzle includes ink-repellent surfaces, an ink-affinitive surface, and a plurality of suction ports. The ink-affinitive surface is concaved with respect to the ink-repellent surfaces and has smaller contact angle of ink than the contact angle of the ink-repellent surfaces. The plurality of suction ports are formed on the ink-affinitive surface.

The following image forming apparatus of ink jet type is known. The image forming apparatus includes a receiving unit and an application member. The receiving unit receives ink discharged from an ink discharge unit. The application member applies ink on an ink discharge face by movement of the receiving unit while contacting the ink discharge face. The image forming apparatus performs the following steps. Ink is attached to the receiving unit of the application member. The ink adhered to the receiving unit is applied to the ink discharge face. The ink discharge face to which ink is applied is wiped with a wiping member.

Furthermore, the following ink jet printer is known. The ink jet printer generates airflow flowing from a box body to an ink discharge face by ink discharge from a first nozzle array arranged at the ink discharge face to a passing port of the box body. Then, the ink newly attached to the ink discharge face is applied broadly by the airflow. This reduces viscosity increase in ink at the nozzle discharge port so as to prevent clogging.

### SUMMARY OF THE INVENTION

A recovery system for a recording head according to the disclosure includes a recording head, at least one wiper, at least one application member, a driving mechanism, and a control unit for controlling the operation of at least the at least one application member and the at least one wiper. The recording head includes a nozzle region where a discharge nozzle has an opening. The nozzle region is configured to discharge ink onto a recording medium. The wiper is configured to pressure-contact a wiping start position outside the nozzle region and to wipe an ink discharge face in a predetermined direction, the ink discharge face including the nozzle region. The application member is configured to apply and spread ink discharged from the nozzle region over the ink discharge face. The driving mechanism is configured to reciprocate the wiper along the ink discharge face and move the wiper in an approaching or separating direction with respect to the ink discharge face. The application member is stopped for a predetermined time at a stop position facing one end of the nozzle region at a predetermined distance from the nozzle region on as to hold the ink discharged from the nozzle region between an upper end face of the application member and a whole region in a width direction of the ink discharge face. The application member is configured to move from the stop position along the ink discharge face so as to apply the ink over the ink discharge face while holding the ink between the upper end face of the application member and the ink discharge face. The wiper is configured to move along the ink discharge face so as to wipe off the ink while contacting the ink discharge face over which the ink is applied.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 schematically illustrates an outline structure of an ink-jet recording apparatus according to embodiments of the disclosure;

FIG. 2 illustrates a first conveyance unit and a recording unit of the ink-jet recording apparatus according to the embodiments viewed from upward;

FIG. 3 illustrates the recording unit according to the embodiments viewed from diagonally upward;

FIG. 4 illustrates recording heads that respectively constitute the line heads of the recording unit according to the embodiments viewed from the side;

FIG. 5 illustrates the recording heads viewed from an ink discharge face side;

FIG. 6 illustrates the cross-sectional configuration of the dot forming unit of the recording heads according to the embodiments;

FIG. 7 schematically illustrates an ink channel from an ink tank to the recording heads of the ink-jet recording apparatus according to the embodiments;

FIG. 8 illustrates a wiping mechanism according to the first embodiment to be mounted on a maintenance unit according to the embodiments viewed from diagonally upward;

FIG. 9 illustrates a carriage that constitutes the wiping mechanism according to the first embodiment viewed from diagonally upward;

FIG. 10 illustrates a supporting frame that constitutes the wiping mechanism according to the first embodiment viewed from diagonally upward;

FIG. 11 illustrates a state where the wiping mechanism is removed from a unit housing of the maintenance unit;

FIG. 12 illustrates an elevating mechanism arranged in the unit housing and a state where the lifting member is in a horizontal state viewed from diagonally upward;

FIG. 13 illustrates the elevating mechanism arranged in the unit housing and a state where the lifting member is in a standing state from the state of FIG. 12 viewed from diagonally upward;

FIG. 14 illustrates a lifting member that constitutes the elevating mechanism viewed from diagonally upward;

FIG. 15 illustrates a state of the maintenance unit located under the recording unit;

FIG. 16 illustrates the carriage, the first wipers, the supporting frame, and the elevating mechanism in the maintenance unit in the state of FIG. 15;

FIG. 17 illustrates a state where the supporting frame and the carriage are lifted by the elevating mechanism from the state of FIG. 16, and the first wipers are arranged at predetermined intervals with the ink discharge face;

FIG. 18 illustrates the recording heads discharging an ink in a state where the first wipers face the near end portion of a nozzle region R;

FIG. 19 illustrates the recording heads discharging the ink in a state where the first wipers face the near end portion of the nozzle region R, viewed from the ink discharge face side;

FIG. 20 illustrates upper end faces of the first wipers;

FIG. 21 illustrates the upper end faces of the first wipers in a state where the ink spreads over concave portions;

FIG. 22 illustrates the recording heads in a state where the first wipers have moved to the end edge of the upstream side of the wiping direction of the ink discharge face from the position in FIG. 18;

FIG. 23 illustrates the recording heads in a state where the first wipers have moved to the end edge of the upstream side of the wiping direction of the ink discharge face, viewed from the ink discharge face;

FIG. 24 illustrates the recording heads in a state where the first wipers have moved to the end edge of the downstream side of the wiping direction of the ink discharge face from the position in FIG. 22;

FIG. 25 illustrates the recording heads in a state where the first wipers have moved to the end edge of the downstream side of the wiping direction of the ink discharge face, viewed from the ink discharge face;

FIG. 26 illustrates a state where the supporting frame and the carriage have been descended by the elevating mechanism to separate the first wipers from the ink discharge face;

FIG. 27 illustrates a state where the carriage has moved to the upstream side of the wiping direction (an arrow A′ direction) from the position in FIG. 26;

FIG. 28 illustrates a state where the supporting frame and the carriage have been lifted by the elevating mechanism, and the carriage moves to an arrow A direction from the position in FIG. 27 so as to wipe off the ink on the ink discharge face;

FIG. 29 illustrates another configuration of the concave portions formed on the upper end faces of the first wipers;

FIG. 30 illustrates the recording heads discharging the ink in a state where the first wipers used for the wiping mechanism according to a second embodiment face the near end portion of the nozzle region R;

FIG. 31 illustrates the recording heads in a state where the first wipers have moved to the end edge of the upstream side of the wiping direction of the ink discharge face from the position in FIG. 30;

FIG. 32 illustrates the recording heads in a state where the first wipers and the second wipers to have moved to the end edge of the downstream side of the wiping direction of the ink discharge face; and

FIG. 33 illustrates the confirmation positions of adhering of ink (1 to 3) of the ink discharge face in Working Example 1.

### DETAILED DESCRIPTION OF THE EMBODIMENTS

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

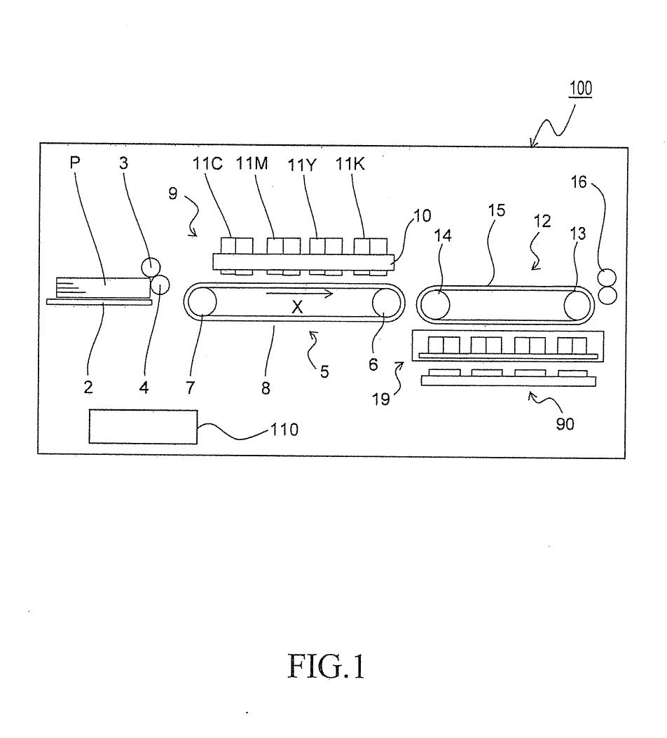

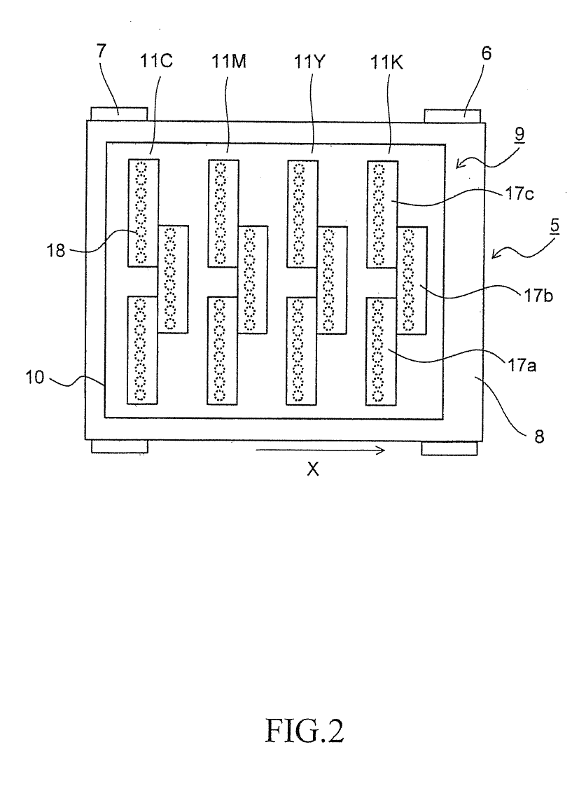

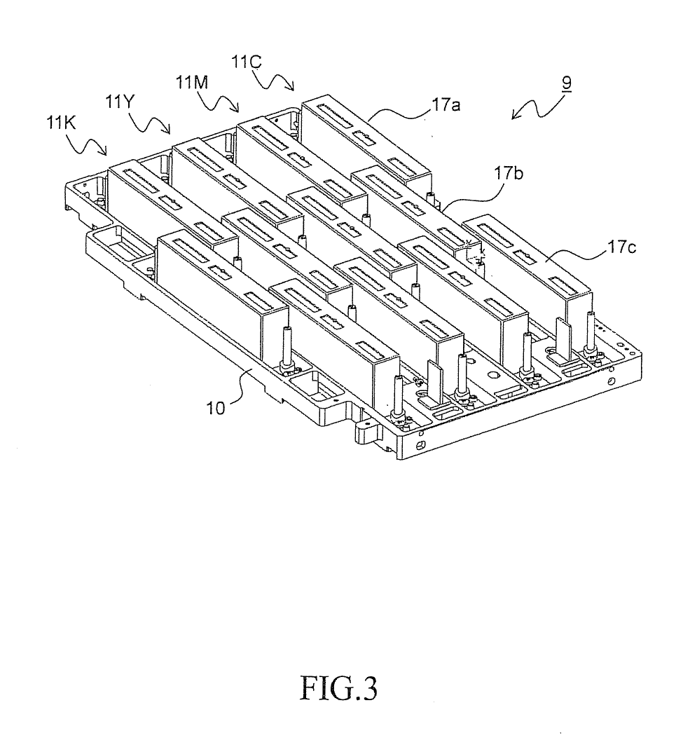

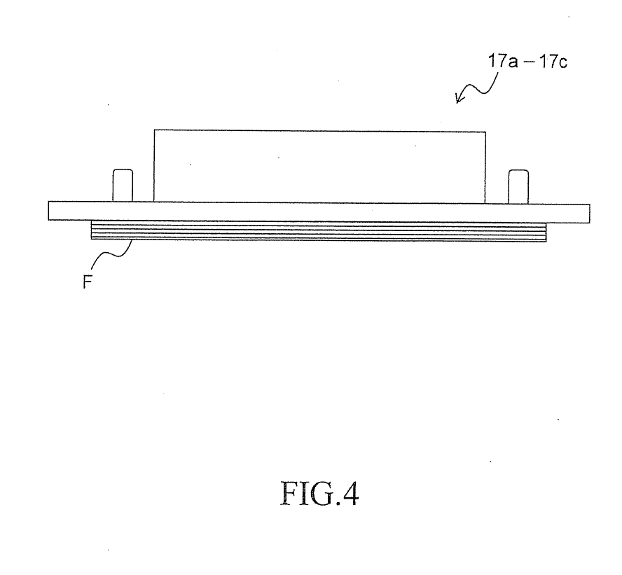

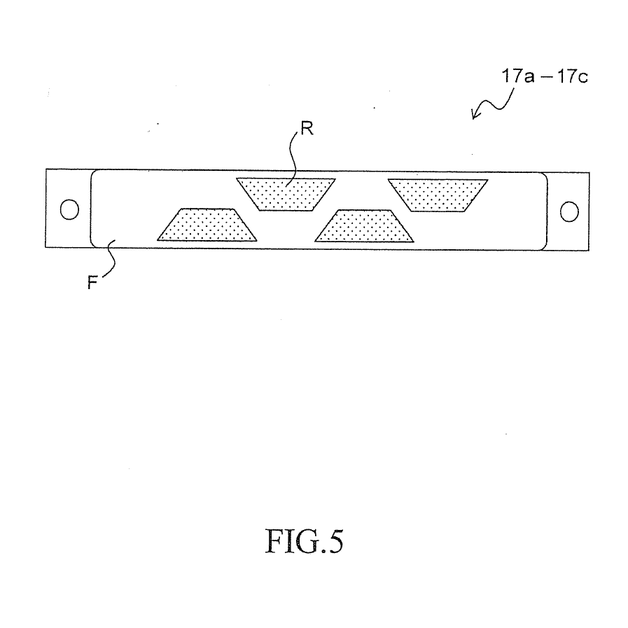

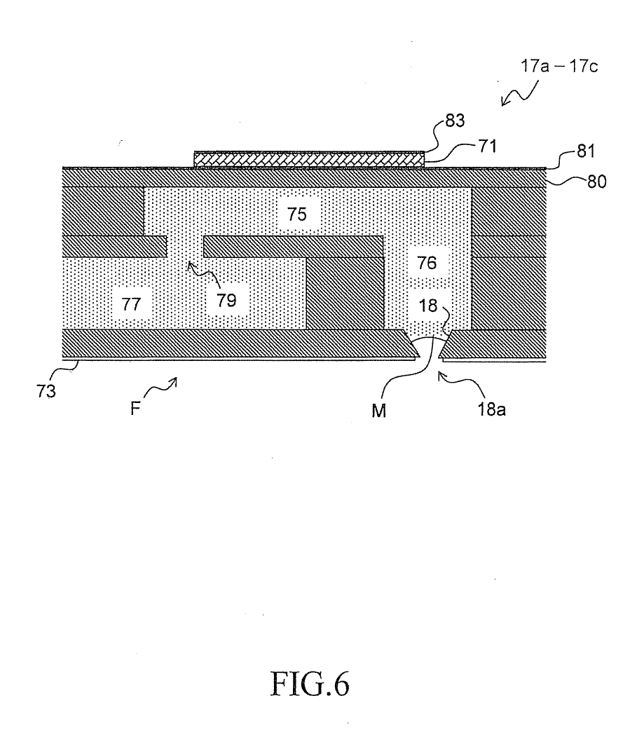

Hereafter, a description will be given of the embodiments of the disclosure with reference to the drawings. FIG. 1 schematically illustrates an outline structure of an ink-jet recording apparatus 100 of the disclosure. FIG. 2 illustrates the first conveyance unit 5 and a recording unit 9 of the ink-jet recording apparatus 100 illustrated in FIG. 1, viewed from upward. FIG. 3 illustrates the recording unit 9 viewed from diagonally upward. FIG. 4 illustrates recording heads 17a to 17c that constitute the line heads 11C to 11K of the recording unit 9. FIG. 5 illustrates the recording heads 17a to 17c viewed from an ink discharge face F side. FIG. 6 illustrates the configuration of the dot forming unit of the recording heads 17a to 17c. FIG. 3 illustrates the recording unit 9 viewed from the deep side (the upper side of FIG. 2) of FIG. 1, and an alignment of the line heads 11C to 11K are reversed with respect to FIG. 1 and FIG. 2. In FIG. 4 and FIG. 6, since the recording heads 17a to 17c have the same formation and configuration, the recording heads 17a to 17c are illustrated as one figure.

As illustrated in FIG. 1, a sheet feed tray 2, which houses paper sheets P as a recording medium, is disposed on the left side portion of the ink-jet recording apparatus 100. The ink-jet recording apparatus 100 includes a paper feed roller 3, at the one end portion of the sheet feed tray 2, that conveys and feeds the paper sheet P, which is housed in the sheet feed tray 2, one by one in order from the paper sheet P loaded on the uppermost inside to the first conveyance unit 5 described below, and a driven roller 4, which is brought into pressure contact with the paper feed roller 3 to rotate.

The first conveyance unit 5 and the recording unit 9 are arranged on the downstream side of the paper feed roller 3 and the driven roller 4 (the right side of FIG. 1) with respect to the paper sheet conveyance direction (an arrow X direction). The first conveyance unit 5 includes first driving roller 6, which are arranged on the downstream side with respect to the paper sheet conveyance direction, first driven roller 7, which are located on the upstream side, and a first conveyance belt 8, which is extended around the first driving rollers 6 and the first driven rollers 7. Rotatably driving the first driving rollers 6 in clockwise conveys the paper sheet P loaded on the first conveyance belt 8 to the arrow X direction.

Locating the first driving roller 6 on the downstream side of the paper sheet conveyance direction causes the first driving rollers 6 to stretch a conveyance surface of the first conveyance belt 8 (the upper side face of FIG. 1). This increases tension of the conveyance surface of the first conveyance belt 8, thus enabling a stable feeding of the paper sheet P. A sheet made of dielectric resin is used for the first conveyance belt 8 and a jointless (seamless) belt is mainly used.

The recording unit 9 includes a head housing 10 and line heads 11C, 11M, 11Y and 11K held by the head housing 10. These line heads 11C to 11K are supported at a height where a predetermined interval, for example 1 mm, is formed with respect to the conveyance surface of the first conveyance belt 8. As illustrated in FIG. 2, a plurality of, in here three pieces of, the recording heads 17a to 17c are located in staggered along with the paper sheet width direction (vertical direction in FIG. 2) that is orthogonal to the paper sheet conveyance direction. The line heads 11C to 11K have the recording region of equal to or more than the width of paper sheet P to be fed. The line heads 11C to 11K may discharge ink onto the paper sheet P conveyed on the first conveyance belt 8 from an ink discharge nozzle 18 that corresponds to the printing position.

As illustrated in FIG. 4 and FIG. 5, the ink discharge faces F of the recording heads 17a to 17c each include nozzle regions R where many ink discharge nozzles 18 are located. As illustrated in FIG. 2 and FIG. 3, three recording heads 17a to 17c that constitute the same line heads 11C to 11K are arranged to have overlappings with their respective end portions so that the ink discharge nozzles 18 located in the respective recording heads 17a to 17c are partially overlapped in the paper sheet conveyance direction.

As illustrated in FIG. 6, a plurality of discharge ports 18a having a minute-diameter as an opening portion of the ink discharge nozzle 18 on the ink discharge face F of the recording heads 17a to 17c are arranged covering the maximum width of at least printing region on the longitudinal direction (main-scanning direction) of the ink discharge face F.

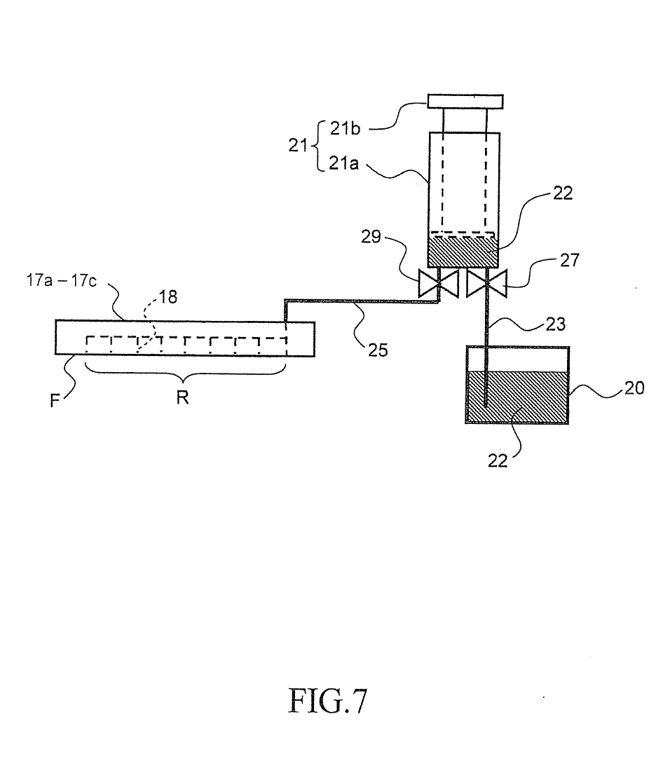

The recording heads 17a to 17c each include a water repellent membrane 73, which covers the portions other than the discharge port 18a of the ink discharge face F, a pressurization chamber 75, which is housed for each discharge port 18a, a nozzle channel 76, which communicates with the pressurization chamber 75 and the ink discharge nozzle 18, and a common channel 77, which supplies ink to a plurality of the pressurization chamber 75 from an ink tank 20 (see FIG. 7) that stores ink. The pressurization chamber 75 communicates with the common channel 77 via a supply hole 79. The ink is supplied to the pressurization chamber 75 from the common channel 77 via the supply hole 79. The ink discharge nozzle 18 communicates with the discharge port 18a from inside of the pressurization chamber 75. Among walls of the pressurization chamber 75, an opposite wall of the ink discharge face F is constituted with a vibration sheet 80. The vibration sheet 80 is continuously formed across a plurality of the pressurization chamber 75. Similarly, on the vibration sheet 80, a common electrode 81 continuously formed across a plurality of the pressurization chamber 75 is laminated. On the common electrode 81, a separate piezoelectric element 71 is located at every pressurization chamber 75. On the piezoelectric element 71, an individual electrode 83 is located at every pressurization chamber 75 so as to sandwich the piezoelectric elements 71 between the common electrode 81 and the individual electrodes 83.

Each piezoelectric element 71 is individually driven by applying a drive pulse generated in a drive pulse generating unit (not illustrated) of a head driving unit on the individual electrode 83. Deformation of the piezoelectric element 71 by this drive is transmitted to the vibration sheet 80, and the pressurization chamber 75 is compressed by the deformation of the vibration sheet 80. As a result, pressure is applied on ink in the pressurization chamber 75 to discharge ink, which passed through the nozzle channel 76 and the ink discharge nozzle 18, from the discharge port 18a on a paper sheet as ink droplets. While no ink droplets are being discharged, ink remains in the ink discharge nozzle 18, and the ink forms a meniscus surface M in the ink discharge nozzle 18.

Four color inks (cyan, magenta, yellow, and black) stored in the respective ink tanks 20 (see FIG. 7) are supplied to the respective recording heads 17a to 17c, which form the respective line heads 11C to 11K, for the respective colors of the line heads 11C to 11K.

Corresponding to the received image data from an external computer or similar unit, each of the recording heads 17a to 17c discharges ink from the ink discharge nozzle 18 toward the paper sheet P, which is conveyed while being suctioned and held to the conveyance surface of the first conveyance belt 8. This forms a color image, which is superposed four color inks, cyan, magenta, yellow and black, on the paper sheet P on the first conveyance belt 8.

In order to prevent a poor ink discharge due to dried or clogged recording heads 17a to 17c, the purge is performed to discharge the ink with high viscosity in the nozzle from the nozzles to prepare for further printing operation as follows. The purge discharges ink from all the ink discharge nozzle 18 of the recording heads 17a to 17c when initial printing after long-term suspension; and the purge discharges ink from ink the ink discharge nozzles 18 of the recording heads 17a to 17c of which ink discharge amount is equal to or less than a predetermined value between printing operation.

Various methods may be employed for the ink discharge method from the recording heads 17a to 17c. Examples include a piezo method, which discharges ink using a piezoelectric element (not illustrated), and a thermal inkjet printing system, which discharges ink by generating bubble with heating element to apply pressure.

Back to FIG. 1, a second conveyance unit 12 is arranged at the downstream side (the right side of FIG. 1) of the first conveyance unit 5 with respect to the paper sheet conveyance direction. The second conveyance unit 12 includes second driving roller 13, which is located on the downstream side with respect to the paper sheet conveyance direction, second driven roller 14, which is located on the upstream side, and a second conveyance belt 15, which is extended around the second driving rollers 13 and the second driven rollers 14. In the second conveyance unit 12, rotatably driving the second driving roller 13 in clockwise conveys the paper sheet P loaded on the second conveyance belt 15 to the arrow X direction.

The paper sheet P having an ink image recorded by the recording unit 9 is sent to the second conveyance unit 12, and the ink discharged on the surface of the paper sheet P is dried while passing via the second conveyance unit 12. A maintenance unit 19, as a recovery system, and a cap unit 90 are arranged below the second conveyance unit 12. The maintenance unit 19 moves under the recording unit 9 when performing the purge described above, wipes off the ink discharged from the ink discharge nozzle 18 of the recording heads 17a to 17c, and recovers the wiped ink. The cap unit 90 horizontally moves under the recording unit 9 when capping the ink discharge face F (see FIG. 4) of the recording heads 17a to 17c, and furthermore moves upward to be attached to the inferior face (the ink discharge surface F) of the recording heads 17a to 17c. Detailed configuration of the maintenance unit 19 will be described below.

A discharge roller pair 16, which discharges the paper sheet P on which an image is recorded, to the outside of the apparatus main body, is located at the downstream side of the second conveyance unit 12 with respect to the paper sheet conveyance direction. At the downstream side of the discharge roller pair 16, a discharge tray (not illustrated), where the paper sheet P discharged to the outside of the apparatus main body is stacked, is located.

Subsequently, the following describes the ink supply from the ink tanks 20 to the recording heads 17a to 17c during printing, and the discharge of ink from the recording heads 17a to 17c during purging. FIG. 7 schematically illustrates the ink channel from the ink tank 20 to the recording heads 17a to 17c of the ink-jet recording apparatus 100 of the disclosure. Ink channels illustrated in FIG. 7 are individually located between the ink tanks 20 of the respective colors and the recording heads 17a to 17c. Here, an ink channel of any one color will be described.

As illustrated in FIG. 7, a syringe pump 21 is arranged between the ink tank 20 and the recording heads 17a to 17c. The ink tank 20 and the syringe pump 21 are connected by a first supply channel 23 made of a tube member. The syringe pump 21 and the common channel 77 (see FIG. 6) in the recording heads 17a to 17c are each connected by a second supply channel 25 made of a tube member.

The first supply channel 23 includes an inflow side valve 27, and the second supply channel 25 includes an outflow side valve 29. Opening or closing the inflow side valve 27 allows and regulates the movement of the ink in the first supply channel 23. Opening or closing the outflow side valve 29 allows and regulates the movement of the ink in the second supply channel 25.

The syringe pump 21 includes a cylinder 21a and a piston 21b. The cylinder 21a is connected to the first supply channel 23 and the second supply channel 25. An ink 22 in the ink tank 20 flows into the cylinder 21a via the first supply channel 23. The ink is supplied from the cylinder 21a via the second supply channel 25, and the supplied ink is supplied to the recording heads 17a to 17c and discharged to a nozzle region R on the ink discharge face F from the ink discharge nozzle 18.

The piston 21b is vertically movable by a drive apparatus (not illustrated). A packing (not illustrated), such as O-ring, is attached to the outer peripheral of the piston 21b to prevent ink leakage from the cylinder 21a, and also allows the piston 21b to slide smoothly along the inner circumferential surface of the cylinder 21a.

During the normal operation (when printing), the inflow side valve 27 and the outflow side valve 29 are open as illustrated in FIG. 7. Stopping and settling the piston 21b at the predetermined position fills an approximately given amount of ink in the cylinder 21a. A surface tension (meniscus) between the cylinder 21a and the recording heads 17a to 17c supplies the ink 22 to the recording heads 17a to 17c from the cylinder 21a.

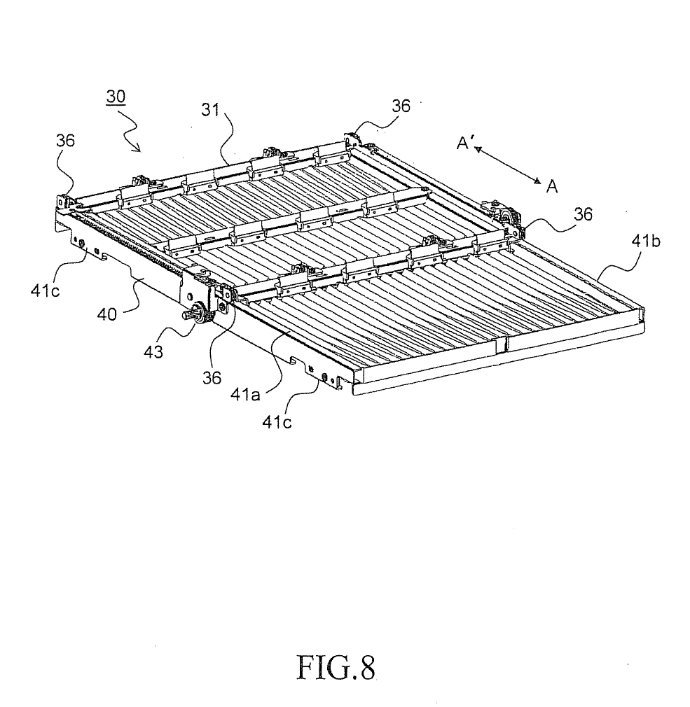

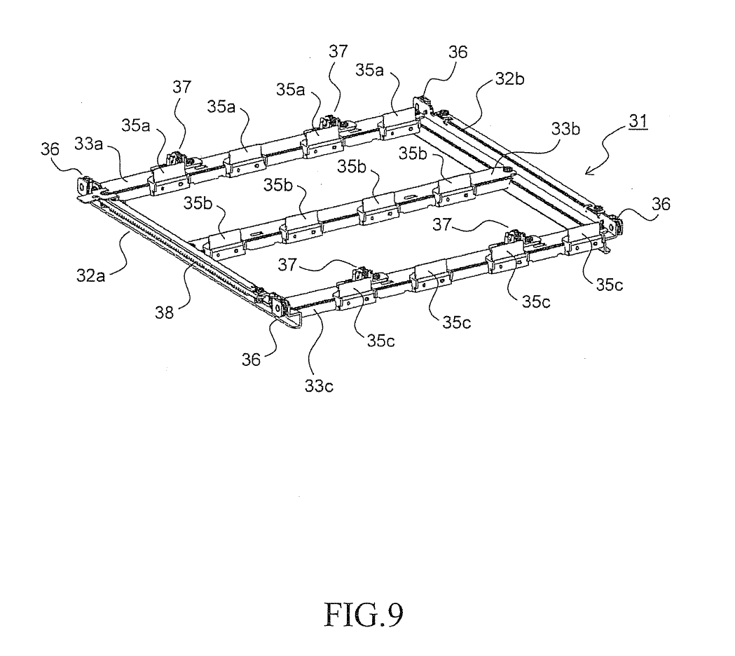

FIG. 8 diagonally illustrates a wiping mechanism 30 according to the first embodiment to be mounted on the maintenance unit 19. The wiping mechanism 30 includes an approximately rectangular-shaped carriage 31 to which the plurality of first wipers 35a to 35c (see FIG. 9) are secured, and a supporting frame 40 for supporting the carriage 31. Rail portions 41a and 41b are formed on the end edges, facing each other, of the upper face of the supporting frame 40. The carriage 31 is slidably supported in an arrow AA′ direction with respect to the supporting frame 40 while sliding rollers 36 housed in four corners of the carriage 31 contacts the rail portions 41a and 41b. Here, the first wipers 35a to 35c function as application members for applying ink 22 over the ink discharge surface F described below.

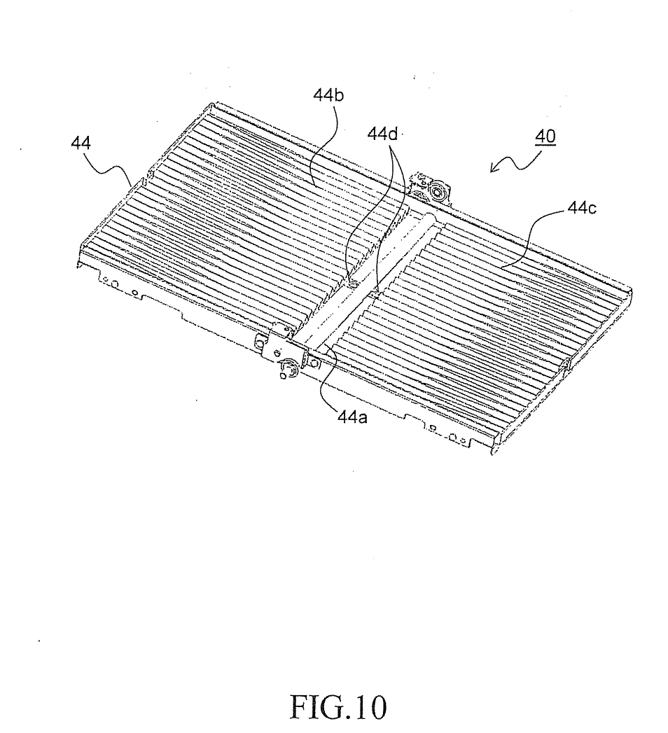

FIG. 9 diagonally illustrates the carriage 31 that constitutes the wiping mechanism 30 according to the first embodiment. FIG. 10 diagonally illustrates the supporting frame 40 that constitutes the wiping mechanism 30 according to the first embodiment. As illustrated in FIG. 9, the carriage 31 is formed as a frame body shape having first stays 32a and 32b, which slidably engage via the sliding rollers 36 on the rail portions 41a and 41b of the supporting frame 40, and second stays 33a, 33b and 33c, which are secured in a bridging-shape between the first stays 32a and 32b.

A rack gear 38, which engages an input gear 43 (see FIG. 8) held in the supporting frame 40, is formed in the first stay 32a. The carriage 31 horizontally (the arrow AA′ direction of FIG. 8) reciprocates along the supporting frame 40 as the input gear 43 rotates in the forward and reverse directions.

The first wipers 35a to 35c are members to wipe off the ink discharged from the ink discharge nozzles 18 of the respective recording heads 17a to 17c. The first wipers 35a to 35c are brought into pressure contact from an approximately vertical direction on a wiping start position outside the nozzle region R (see FIG. 5) where nozzle faces of the ink discharge nozzles 18 are exposed. By a movement of the carriage 31 in a predetermined direction (the arrow A direction in FIG. 9), the first wipers 35a to 35c wipe the ink discharge face F including the nozzle region R.

Four first wipers 35a are secured to the second stay 33a at approximately equal intervals. Similarly, four first wipers 35b and four first wipers 35c are respectively secured to the second stays 33b and 33c at approximately equal intervals. The first wipers 35a and 35c are arranged at the positions corresponding to the respective recording heads 17a and 17c (see FIG. 3) on the left and right that constitute the respective line heads 11C to 11K. The first wipers 35b are located at the positions corresponding to a recording heads 17b in the center (see FIG. 3) that constitute the respective line heads 11C to 11K. The first wipers 35b are secured shifted by a predetermined distance with respect to the first wipers 35a and 35c in a direction perpendicular to the moving direction of the carriage 31 (the arrow AA′ direction in FIG. 8).

Gap rollers 37 are located on four locations of the top faces of the second stays 33a and 33c. The gap rollers 37 contact the head housing 10 of the recording unit 9 when lifting the wiping mechanism 30 to the recording unit 9 side in order to perform the wiping operation of the ink discharge faces F of the recording heads 17a to 17c by the first wipers 35a to 35c. This causes the first wipers 35a to 35c to keep a constant contact with the ink discharge faces F.

As illustrated in FIG. 10, an ink collecting tray 44 to collect the wiped waste ink on the ink discharge face F by the first wipers 35a to 35c is arranged on the top face of the supporting frame 40. A groove portion 44a is formed along the extending direction of the second stays 33a to 33c at the substantially central part of the ink collecting tray 44. Tray surfaces 44b and 44c at both sides across the groove portion 44a are formed in a downward pitch toward the groove portion 44a. An ink discharge hole 44d is located in the groove portion 44a, and the bottom of the groove portion 44a is in a form of downward pitch toward the ink discharge hole 44d.

The ink discharge face F is wiped by the first wipers 35a to 35c. Waste ink dropped to the tray surfaces 44b and 44c is collected in the groove portion 44a, then flows toward the ink discharge hole 44d in the groove portion 44a. Subsequently, the waste ink passes via an ink collecting channel (not illustrated) connected to the ink discharge hole 44d, and is collected in a waste ink collection tank (not illustrated).

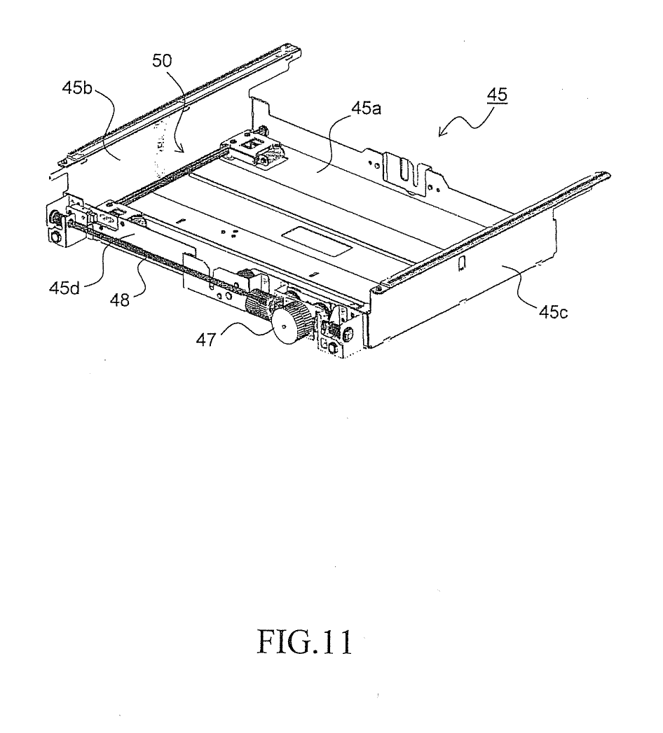

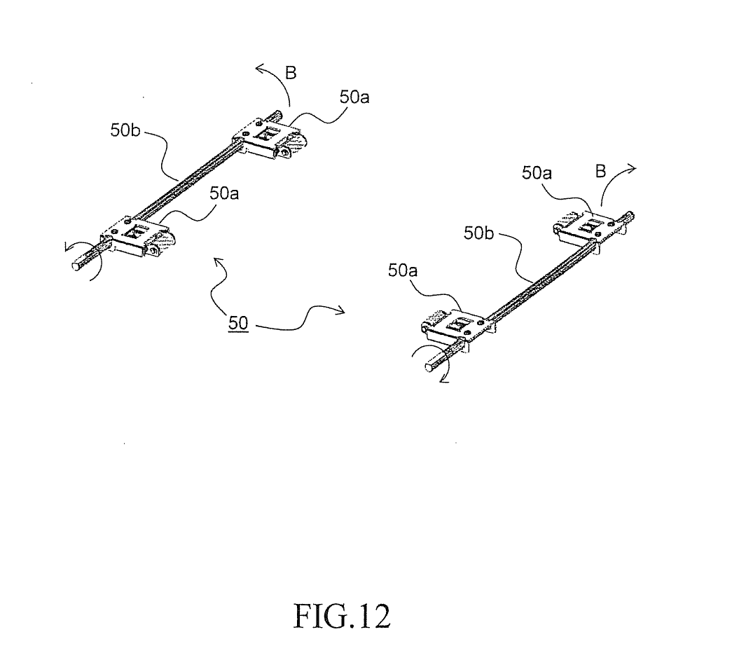

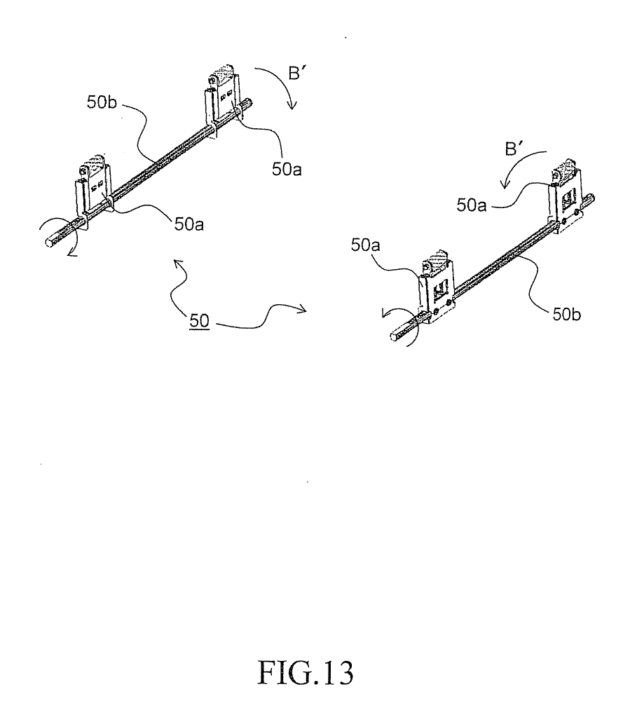

The following describes an elevating mechanism 50 for lifting the wiping mechanism 30 according to the first embodiment. FIG. 11 illustrates a state where the wiping mechanism 30 is removed from a unit housing 45 of the maintenance unit 19. FIG. 12 and FIG. 13 illustrate the elevating mechanism 50 to be arranged in the unit housing 45. A pair of elevating mechanisms 50 where two lifting members 50a are each secured to both the ends of a shaft 50b is located along side faces 45b and 45c, facing each other along the moving direction of the carriage 31 (the arrow AA′ direction of FIG. 8), on a bottom face 45a of the unit housing 45. That is, the elevating mechanisms 50 are located in a position that faces both the ends of the head housing 10 of the recording unit 9 in the width direction (upper and lower and portions of FIG. 2). In FIG. 11, the description of the elevating mechanisms 50 in the side face 45c side is omitted. A motor 47 and a drive transmission shaft 48, which transmits rotatably driving force of the motor 47 to a shaft 50b, are mounted in a side face 45d adjacent to side faces 45b and 45C of the unit housing 45.

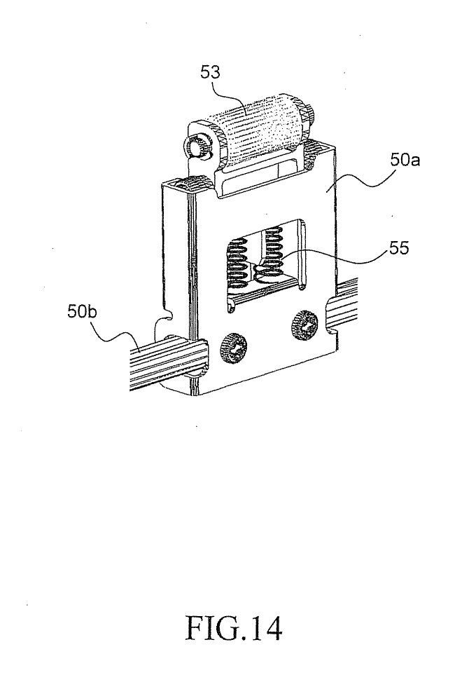

FIG. 14 illustrates the lifting member 50a that constitutes the elevating mechanism 50. The lower end portions of the lifting member 50a is secured to the shaft 50b, and press-up rollers 53 are rotatably mounted in the upper end portions of the lifting members 50a. The press-up rollers 53 are engaged to an engagement part 41c (see FIG. 8) formed in the lower end portion of the supporting frame 40, and are able to move rotatably along the engagement part 41c. Therefore, friction between the supporting frame 40 and the lifting member 50a when operating the elevating mechanism 50 is reduced by rotation of the press-up rollers 53, enabling a smooth elevating operation. The press-up rollers 53 are biased in the separating direction (upward direction in FIG. 14) from the shaft 50b by a coil spring 55.

Rotating clockwise the shaft 50b of the elevating mechanism 50 in the right side and rotating anticlockwise the shaft 50b of the elevating mechanism 50 in the left side from the position of FIG. 12 erect the lifting members 50a fallen inside the unit housing 45 toward the outside direction (an arrow B direction), and then the press-up rollers 53 move to the outer end portions of the engagement part 41c. This causes the lifting member 50a to switch to an erected state (the state illustrated in FIG. 13) from the horizontal state, thus lifting the carriage 31 along with the supporting frame 40.

On the other hand, rotating anticlockwise the shaft 50b of the elevating mechanism 50 in the right side and rotating clockwise the shaft 50b of the elevating mechanism 50 in the left side from the position of FIG. 13 take down the lifting member 50a inside direction of the unit housing 45 (an arrow B′ direction), and then the press-up rollers 53 move to the inner end portions of the engagement part 41c. This causes the lifting member 50a to switch to the horizontal state (the state illustrated in FIG. 12) from the erected state, thus lifting the carriage 31 down along with the supporting frame 40.

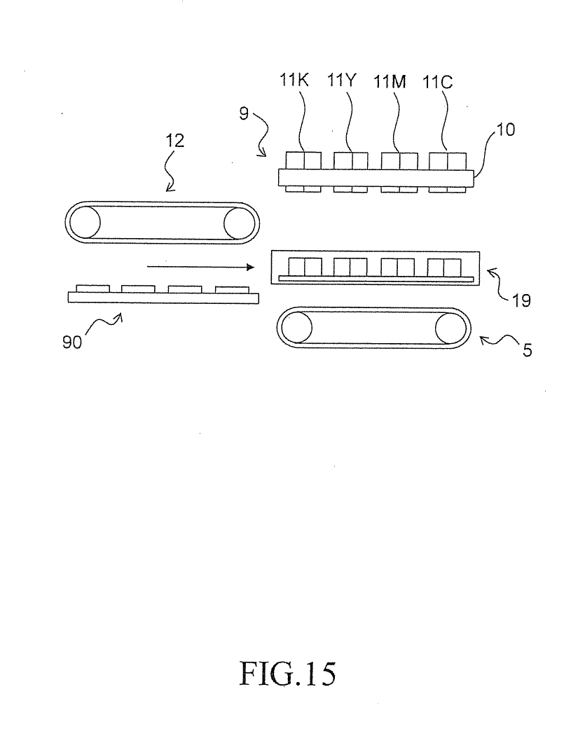

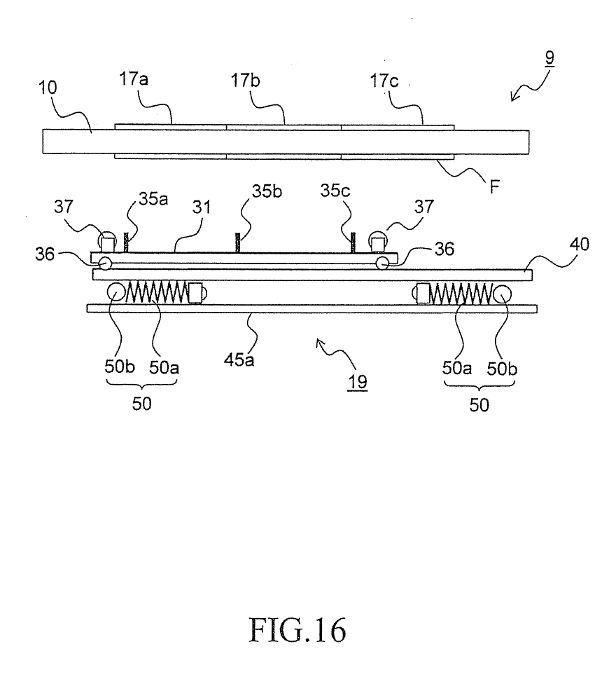

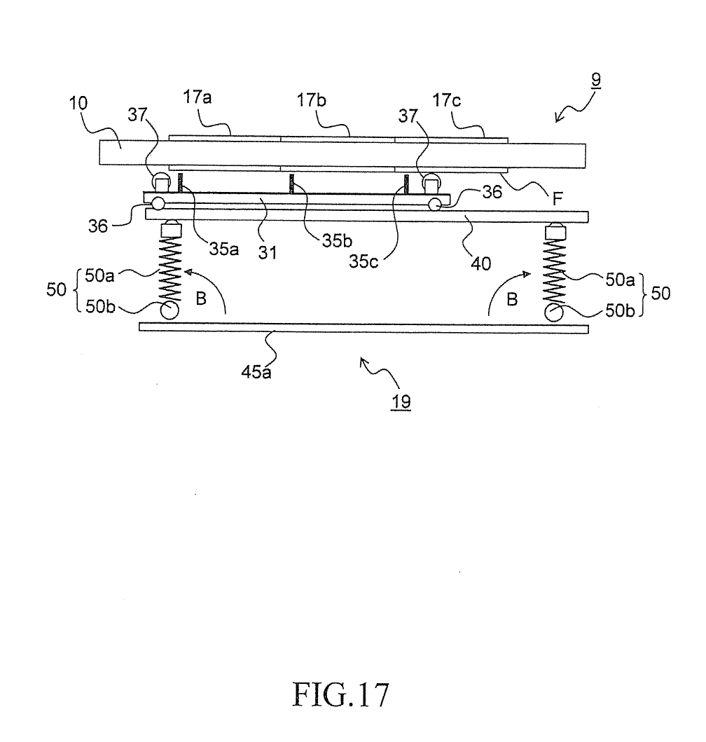

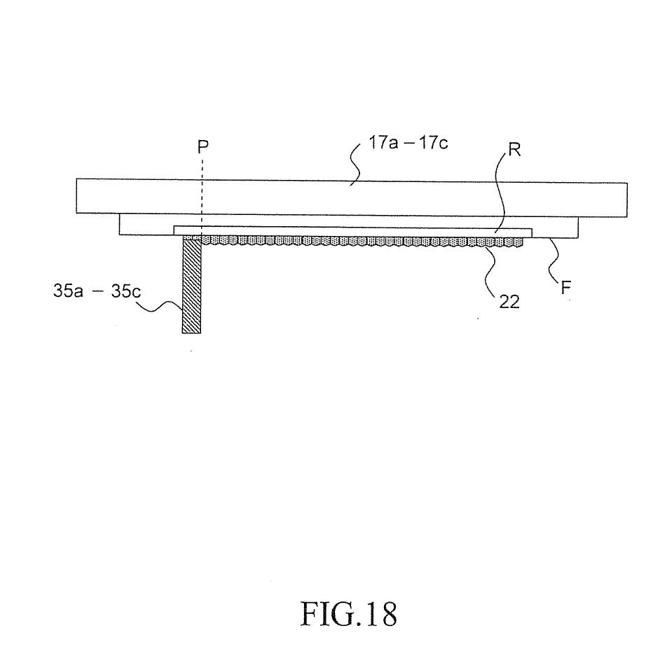

The following describes the recovery operation for the recording heads 17a to 17c using the wiping mechanism 30 according to the first embodiment in the ink-jet recording apparatus 100 of the disclosure. FIG. 15 illustrates the state of the maintenance unit 19 positioned under the recording unit 9. FIG. 16 illustrates a positional relationship between the recording heads 17a to 17c and the first wipers 35a to 35c when starting the wiping operation. FIG. 16, and FIG. 17, FIG. 18 and FIG. 23 to FIG. 25, which will be described later, illustrate a state of the recording unit 9 and the maintenance unit 19 viewed from the downstream side of the paper sheet conveyance direction (the left side of FIG. 15). The supporting frame 40 is simply illustrated plate-shaped, and only the bottom face 45a is illustrated for the unit housing 45. This recovery operation is performed by a control unit 110 in the ink-jet recording apparatus 100 of the disclosure. This control unit 110 may be achieved by installing a recovery operation program stored in a non-transitory computer-readable recording medium. The recovery operation program causes the ink-jet recording apparatus 100 to perform the recovery operation.

When performing the recovery operation for the recording heads 17a to 17c, the first conveyance unit 5 positioned under the recording unit 9 is lifted down first as illustrated in FIG. 15. Then, the maintenance unit 19 situated under the second conveyance unit 12 is moved horizontally to between the recording unit 9 and the first conveyance unit 5. As illustrated in FIG. 16, in this state, the lifting members 50a of the elevating mechanism 50 is in a horizontal state, and the first wipers 35a to 35c secured to the carriage 31 are separated from the ink discharge faces F of the recording heads 17a to 17c.

### Ink Holding Process

Prior to the wiping operation, the first wipers 35a to 35c are positioned at stop positions P (positions having a predetermined distance from the end portions of the nozzle regions R of the ink discharge faces F of the recording heads 17a to 17c). Specifically, the supporting frame 40 and the carriage 31 are lifted by rotating the shafts 50b of the elevating mechanism 50 so as to erect the lifting members 50a toward the arrow B direction as illustrated in FIG. 17. A distance between the first wipers 35a to 35c and the ink discharge faces F is set to an enough space to cause the ink 22 discharged on the ink discharge faces F to be held between the ink discharge faces F and the upper end faces of the first wipers 35a to 35c.

Subsequently, closing the inflow side valve 27 (see FIG. 7) and then applying pressure on the syringe pump 21 (see FIG. 7) supplies the ink 22 in the cylinder 21a to the recording heads 17a to 17c via the second supply channel 25. The supplied ink 22 is forcibly discharged (purged) from the ink discharge nozzles 18. This purging operation discharges the ink with increased viscosity, foreign objects, and bubbles in the ink discharge nozzles 18 to recover the recording heads 17a to 17c.

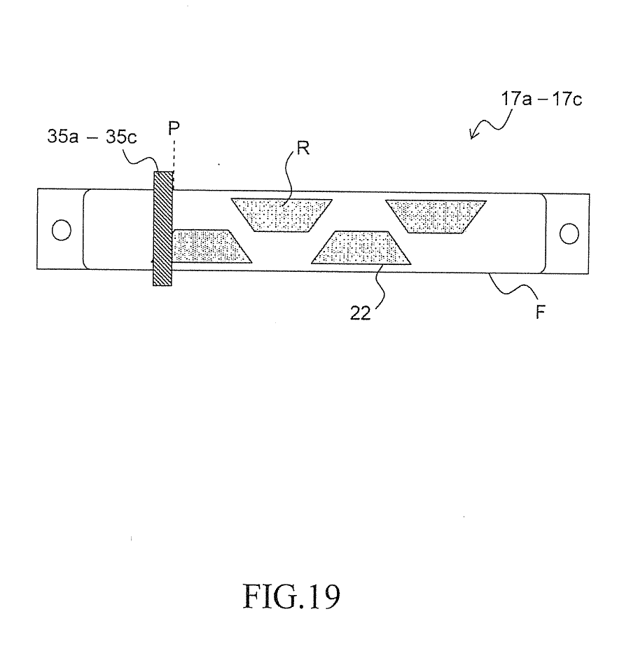

FIG. 18 and FIG. 19 illustrate the recording heads 17a to 17c in a state where the ink 22 is discharged while each of the first wipers 35a to 35c is facing the near end portion of the nozzle region R. As illustrated in FIG. 18, the ink 22 discharged from the ink discharge nozzles 18 contacts the upper end faces (counter faces) of the first wipers 35a to 35c. As illustrated in FIG. 19, the ink 22 is discharged on the ink discharge face F along the shape of the nozzle region R where the ink discharge nozzles 18 exist. Thus, the discharged ink 22 contacts only a part (the lower end side of FIG. 19) of the longitudinal direction of the first wipers 35a to 35c.

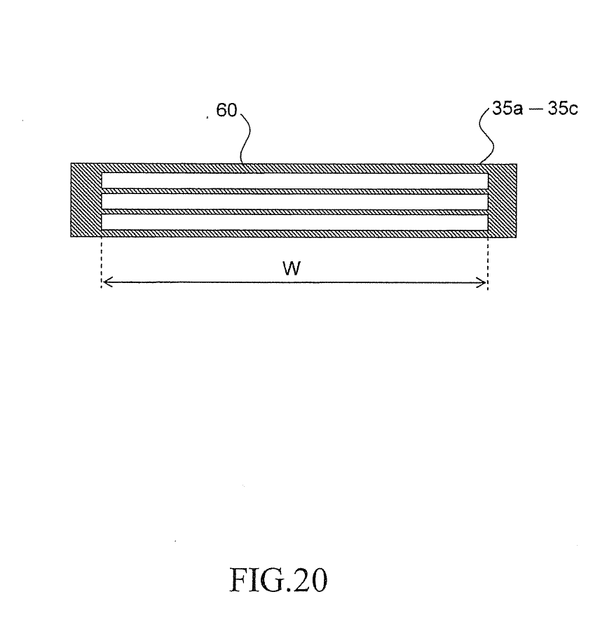

FIG. 20 illustrates the upper end faces of the first wipers 35a to 35c. As illustrated in FIG. 20, groove shaped concave portions 60, which are holding structures of the ink 22, are formed on the upper end faces of the first wipers 35a to 35c. The concave portions 60 are formed to have a length of equal to or more than the width W of the ink discharge face F along the longitudinal direction (the width direction of the ink discharge face F) of the first wipers 35a to 35c.

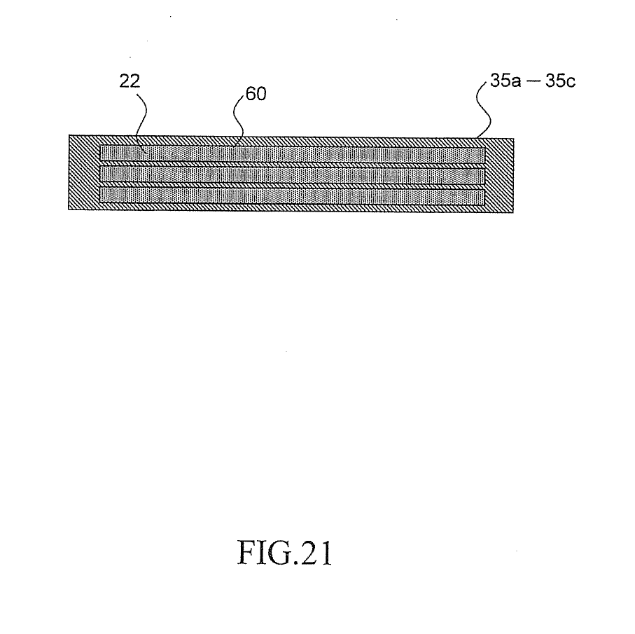

As illustrated in FIG. 21, this causes the ink 22 in contact with one end of the upper end face of the first wipers 35a to 35c to spread to the other end side along the concave portions 60 by a capillary phenomenon, as illustrated in FIG. 21. As a result, the ink 22 is held in throughout the counter faces region of the upper end faces of the first wipers 35a to 35c and the ink discharge faces F.

After the first wipers 35a to 35c are positioned opposing the ink discharge faces F at a predetermined spacing, the ink 22 is discharged from the nozzle regions R to be held on the upper end faces of the first wipers 35a to 35c. However, the first wipers 35a to 35c may be brought in close to the ink discharge faces F so as to contact the ink 22 after discharging the ink 22.

However, with a procedure to bring the first wipers 35a to 35c close to the ink discharge faces F after discharging the ink 22, especially if the ink discharge surfaces F 22 have high water repellency, the ink 22 discharged on the ink discharge face F may drop or has a high viscosity as dryness progresses before contacting the first wipers 35a to 35c. As described above, it is preferred to follow the procedure to discharge the ink 22 after positioning the first wipers 35a to 35c opposed to the ink discharge faces F with a predetermined interval because the ink 22 does not drop or dry and is surely held in throughout the counter face region of the upper end faces of the first wipers 35a to 35c and the ink discharge face F.

### Ink Application Process

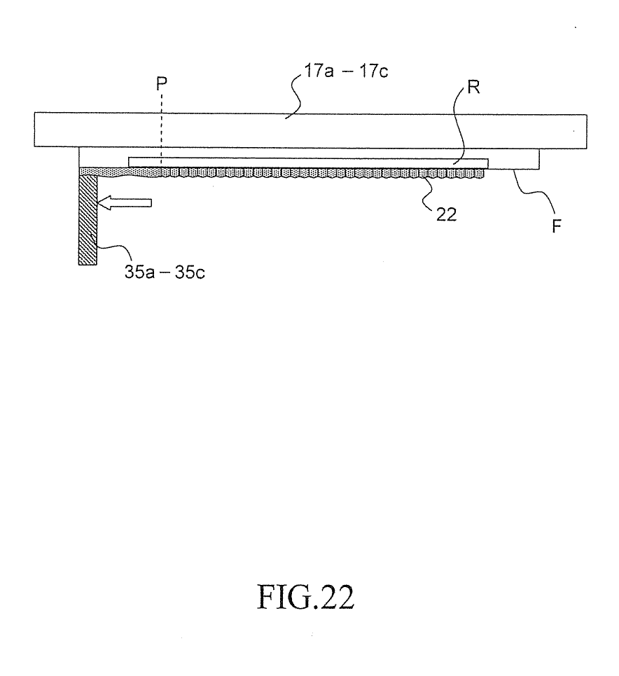

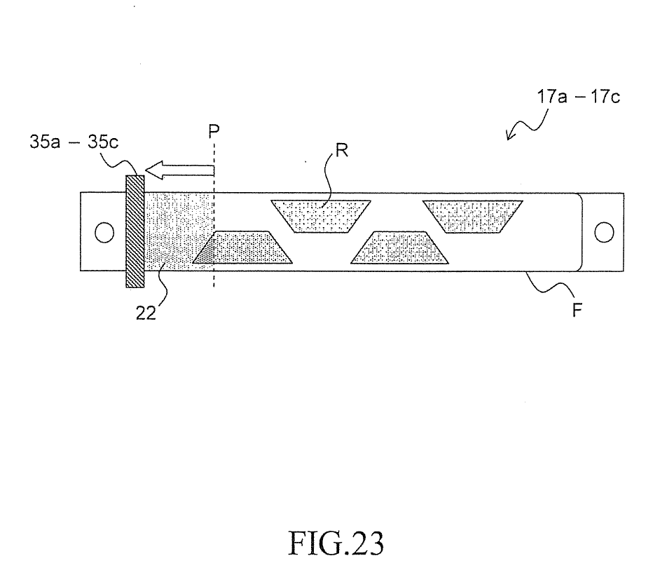

The first wipers 35a to 35c are stopped for a certain time until the ink 22 spreads through the whole counter face regions of the upper end faces of the first wipers 35a to 35c and the ink discharge faces F. Subsequently, the first wipers 35a to 35c are moved to end edges (a first end edge) of the ink discharge faces F of the opposite direction (upstream side of the wiping direction) of the nozzle regions R while keeping the distance from the ink discharge faces F. Specifically, the carriage 31 is moved to the arrow A′ direction by rotating the input gear 43 (see FIG. 8) in the reverse direction while maintaining the height of the lifting members 50a. FIG. 22 and FIG. 23 illustrate the recording heads 17a to 17c in a state where the respective first wipers 35a to 35c are moved to the end edge of the upstream side of the wiping direction of the ink discharge face F. As illustrated in FIG. 23, the ink 22 is applied and spreads all over the surface of the ink discharge face F of the upper stream side (the left side of FIG. 23) from a stop positions P of the first wipers 35a to 35c (the first application process).

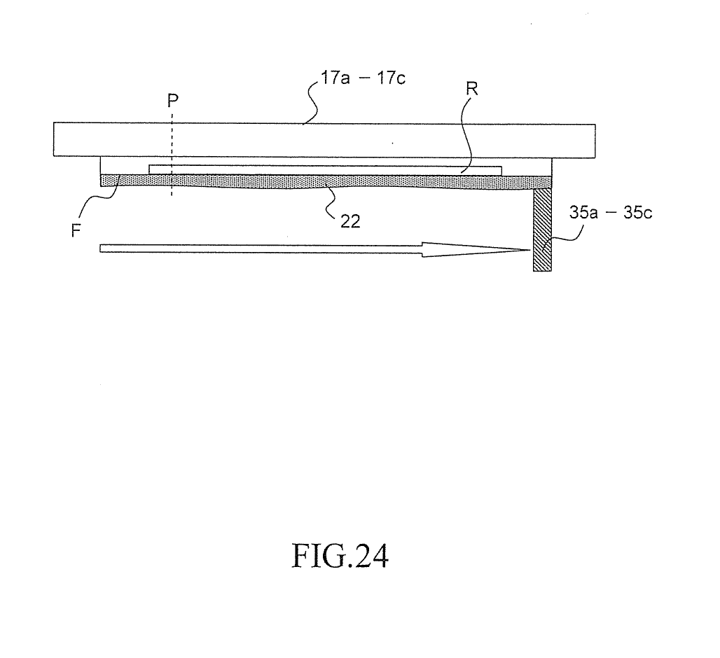

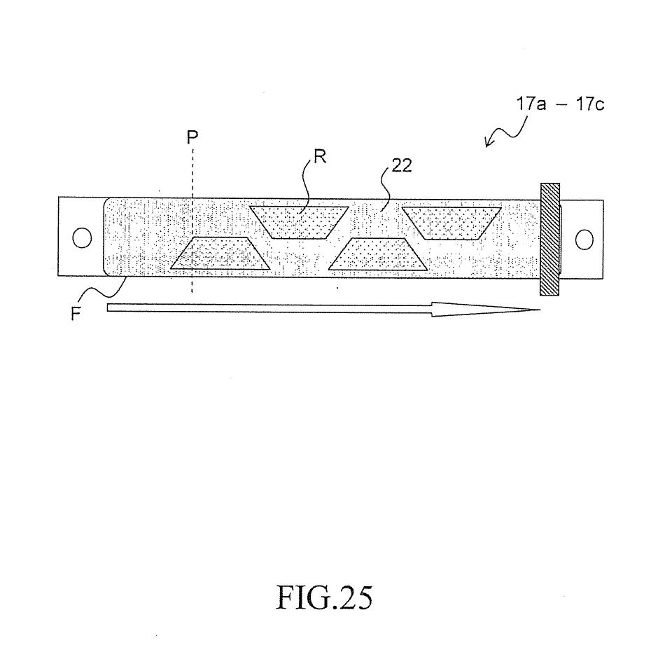

While maintaining the distance from the ink discharge faces F, the first wipers 35a to 35c are moved to end edges (a second end edge) of the ink discharge faces F of the opposite direction (the downstream side of the wiping direction) from the positions of the first wipers 35a to 35c in FIG. 22. Specifically, the carriage 31 is moved to the arrow A direction by rotating the input gear 43 (see FIG. 8) positively while maintaining the height of the lifting members 50a. FIG. 24 and FIG. 25 illustrate the recording heads 17a to 17c in a state where the respective first wipers 35a to 35c have moved to the end edge of the downstream side of the wiping direction of the ink discharge face F. As illustrated in FIG. 25, the ink 22 is also applied and spreads all over the surface of the ink discharge faces F of the downstream side (the right side of FIG. 25) from the stop positions P of the first wipers 35a to 35c. As a result, the ink 22 is evenly applied and spreads over the whole ink discharge faces F including the nozzle regions R (the second application process).

### Ink Wiping Process

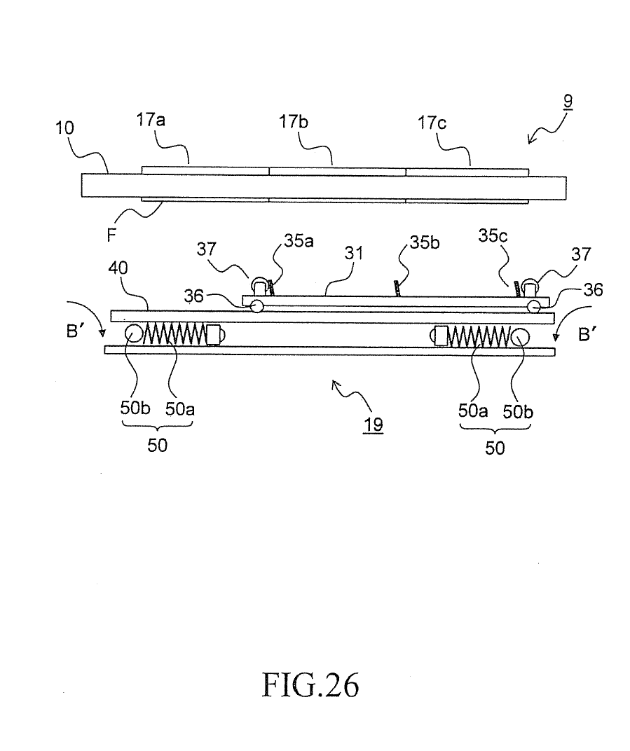

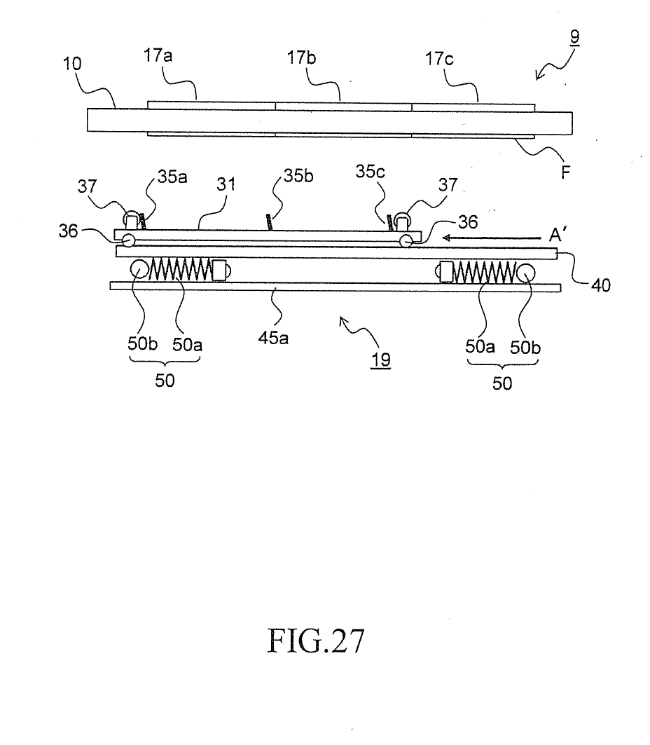

Subsequently, the wiping operation to wipe off the ink 22 discharged on the ink discharge face F is performed. Specifically, as illustrated in FIG. 26, rotating the shafts 50b of the elevating mechanism 50 to take down the lifting members 50a to the arrow B′ direction lifts down the supporting frame 40 and the carriage 31. As a result, the first wipers 35a to 35c are retreated from the ink discharge face F of the recording heads 17a to 17c downward. Afterwards, as illustrated in FIG. 27, the maintenance unit 19 is returned to the state of FIG. 16 again by rotating the input gear 43 in the reverse direction to move the carriage 31 to the arrow A′ direction.

The supporting frame 40 and the carriage 31 are lifted more upwards than those in the state in FIG. 17 by rotating the shafts 50b of the elevating mechanism 50 to erect the lifting members 50a toward the arrow B direction. As a result, the first wipers 35a to 35c are brought into pressure contact with wiping start positions (near the end portions of the upstream side of the ink discharge face F) of the ink discharge faces F of the recording heads 17a to 17c. At this time, the gap rollers 37 located in the carriage 31 is being pressed against the inferior face of the head housing 10 by biasing force of the coil spring 55 (see FIG. 14) of the lifting member 50a. This brings the first wipers 35a to 35c into pressure contact with the ink discharge faces F at a constant pressure all the time.

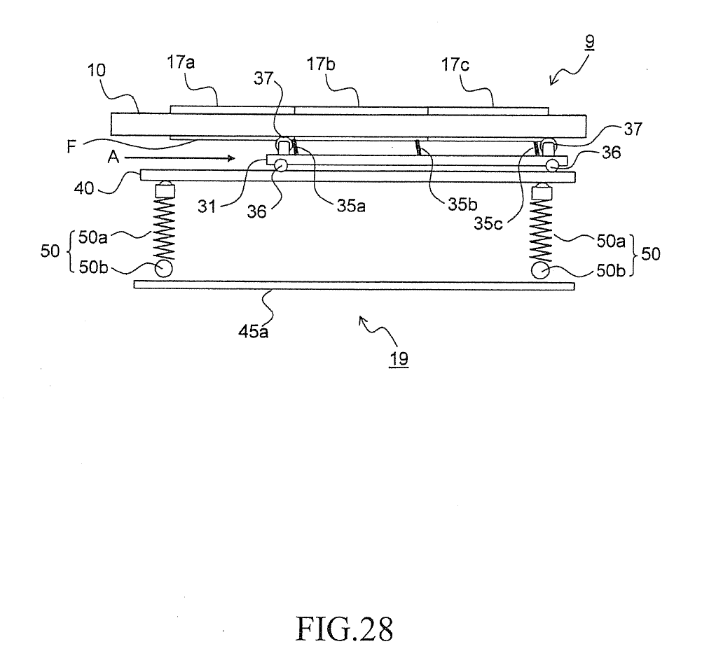

Rotating the input gear 43 (see FIG. 8) positively to move the carriage 31 toward the arrow A direction as illustrated in FIG. 28 causes the first wipers 35a to 35c to wipe off the ink 22 that is applied and spreads over the whole ink discharge face F of the recording heads 17a to 17c. At this time, since an upward direction force is acting on the supporting frame 40 by the elevating mechanism 50, the carriage 31 is moved toward the arrow A direction while maintaining the state where the gap rollers 37 are pressed against the head housing 10. Waste ink wiped by the first wipers 35a to 35c are recovered in the ink collecting tray 44 (see FIG. 10).

The first wipers 35a to 35c move to the end portions of the downstream side of the ink discharge faces F of the respective recording heads 17a to 17c (the right end of FIG. 28). Subsequently, as illustrated in FIG. 26 and FIG. 27, the first wipers 35a to 35c are retreated downward from the ink discharge faces F of the recording heads 17a to 17c. Then, the maintenance unit 19 is returned to the state of FIG. 16 by moving the carriage 31 to the arrow A′ direction. Finally, the maintenance unit 19 positioned between the recording unit 9 and the first conveyance unit 5 is moved horizontally and is positioned under the second conveyance unit 12. The recovery operation of the recording heads 17a to 17c is complete by lifting the first conveyance unit 5 to a predetermined position.

When attaching the cap unit 90 to the recording heads 17a to 17c, first of all, a first conveyance unit 5 positioned to face the inferior face of the recording unit 9 is lifted down as illustrated in FIG. 15. The cap unit 90 positioned under the second conveyance unit 12 is then moved horizontally between the recording unit 9 and the first conveyance unit 5, so as to position the cap unit 90 to the position facing the recording unit 9.

Subsequently, the cap unit 90 is pushed up by lifting the first conveyance unit 5. Stopping the elevation of the first conveyance unit 5 when the cap unit 90 is set in close contact with the recording heads 17a to 17c completes the attachment of the cap unit 90.

According to the configuration of this embodiment, the ink 22 is applied and spreads over the whole ink discharge faces F by moving the first wipers 35a to 35c while holding the ink 22 between the upper end faces of the first wipers 35a to 35c and the ink discharge faces F facing the upper end faces of the first wipers 35a to 35c. Therefore, the first wipers 35a to 35c can wipe off the dried mist and foreign object, such as paper dust, adhering to other than the nozzle region R, by re-dispersing in the ink 22 immediately after discharge.

Mist adhered to the upstream side of the nozzle region R can be removed by moving the first wipers 35a to 35c, where the ink 22 is held on the whole counter face regions thereof facing the ink discharge faces F, to the end edges of the upstream side of the wiping direction of the ink discharge faces F. Therefore, since mist adhered to regions of the ink discharge surfaces F where the cap unit 90 contacts can also be removed, reduction in sealability when mounting the cap unit 90 due to adhered mist can be effectively suppressed.

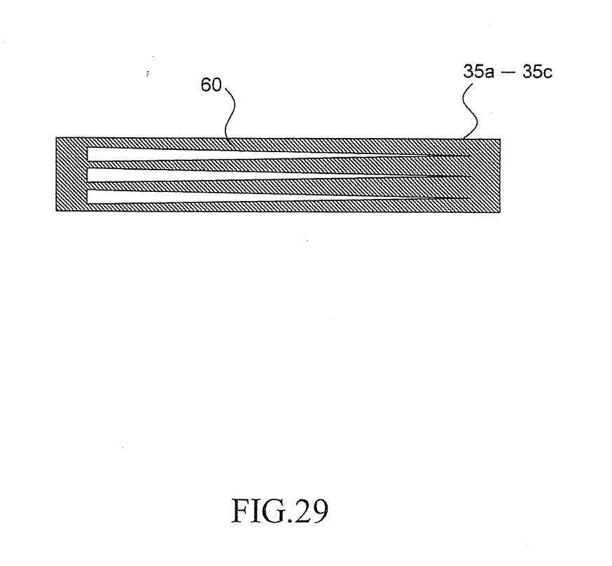

FIG. 29 illustrates another configuration of the concave portions 60 formed on the upper end faces of the first wipers 35a to 35c. As illustrated in FIG. 29, the concave portions 60 has a tapered shape gradually widened in its groove width from one end side of the longitudinal direction (the width direction of the ink discharge face F) of the first wipers 35a to 35c to the other end side. Similarly to the configuration illustrated in FIG. 20, the concave portions 60 is formed to have a length of equal to or more than the width W of the ink discharge face F.

According to this configuration, the ink 22 that contacts the narrow groove width portions of the concave portions 60 spreads toward the broad side of the groove width (the left side of FIG. 29) promptly by positioning the first wipers 35a to 35c such that the narrow side (the right side of FIG. 29) of the groove width of the concave portions 60 faces the nozzle region R. This can shorten the stop time of the first wipers 35a to 35c at the stop position P.

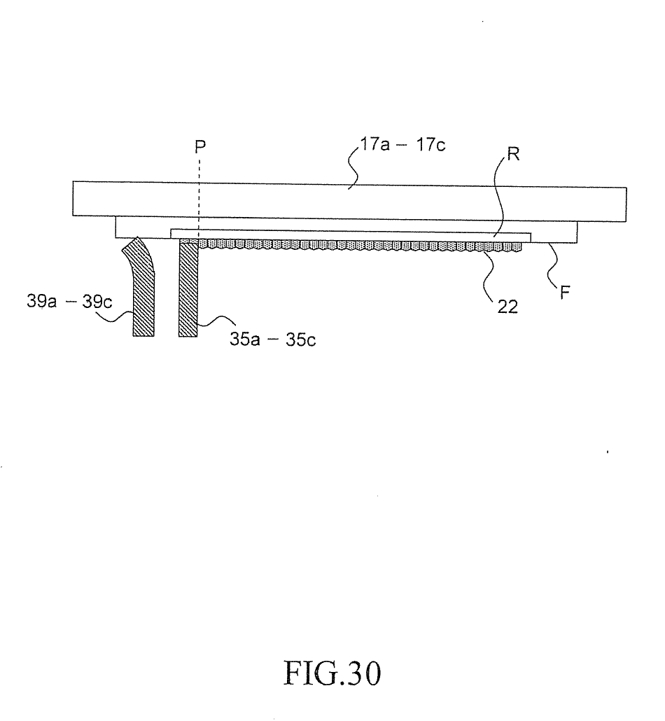

FIG. 30 illustrates the recording heads 17a to 17c in a state where the ink 22 is discharged while the first wipers 35a to 35c used for the wiping mechanism 30 in the second embodiment face the near end portions of the nozzle regions R. The wiping mechanism 30 of this embodiment includes second wipers 39a to 39c, in addition to the first wipers 35a to 35c, secured on the carriage 31. The second wipers 39a to 39c are arranged at the upstream side of the first wipers 35a to 35c in the wiping direction (from the left to right direction of FIG. 30) at a predetermined interval from the first wipers 35a to 35c. The description of other configuration of the wiping mechanism 30 is omitted because it is same as that of the first embodiment.

The second wipers 39a to 39c project upward (the ink discharge face F side) with respect to the first wipers 35a to 35c. As illustrated in FIG. 30, the second wipers 39a to 39c are brought into pressure contact with the ink discharge faces F at a predetermined pressure while the first wipers 35a to 35c are facing the ink discharge faces F.

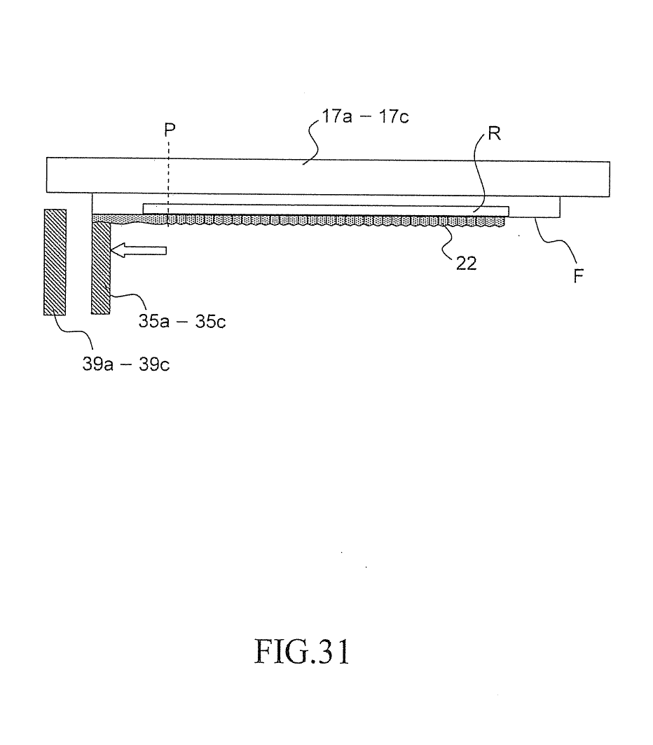

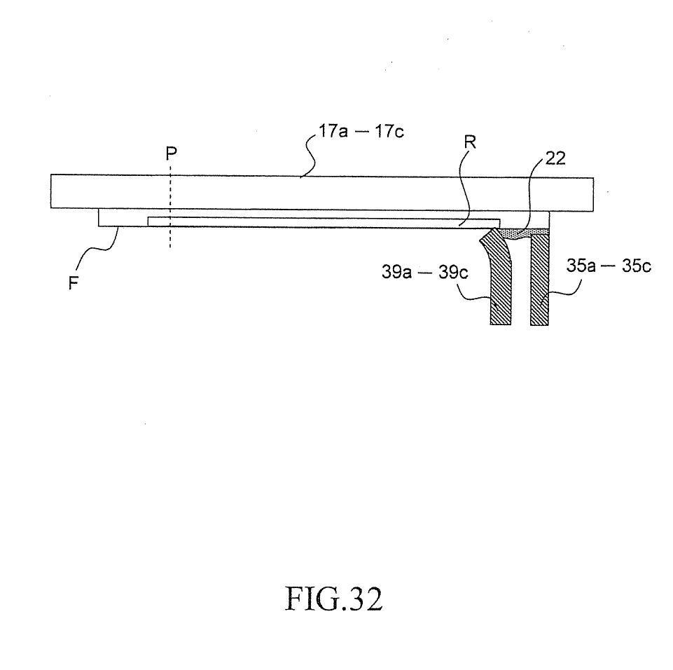

Similarly to the first embodiment, moving the first wipers 35a to 35c from the state of FIG. 30 to the end edge of the upstream side of the wiping direction of the ink discharge face F applies and spreads the ink 22 over the whole ink discharge faces F of the upstream side (the left side of FIG. 31) from the stop positions P of the first wipers 35a to 35c as illustrated in FIG. 31. Subsequently, as illustrated in FIG. 32, moving the first wipers 35a to 35c to the end edge of the downstream side of the wiping direction of the ink discharge face F applies and spreads the ink 22 over the whole ink discharge faces F of the downstream side (the right side of FIG. 32) from the stop position P. Furthermore, the second wipers 39a to 39c arranged at the upstream side of the first wipers 35a to 35c in the wiping direction wipe off the ink 22 applied and spread by the first wipers 35a to 35c.

This allows an operation of moving the carriage 31 once to the wiping direction to apply and wipe off the ink 22 on the ink discharge faces F of the recording heads 17a to 17c. As a result, a wiping time can be shortened compared with the first embodiment where the ink 22 is wiped using the first wipers 35a to 35c.

A certain time may be required to re-disperse the dried mist in the ink 22. In the second embodiment, the ink 22 applied and spread by the first wipers 35a to 35c are immediately wiped off by the second wipers 39a to 39c. Thus, it is preferred configuration to perform an ink wiping process after moving the first wipers 35a to 35c to the upstream side of the wiping direction after completing the ink 22 application process in a manner such as the first embodiment in order to ensure enough time (interval) for dispersing the dried mist in the ink 22.

Note that, in the second embodiment, the first wipers 35a to 35c are only used to apply and spread the ink 22 over the whole ink discharge faces F. The second wipers 39a to 39c wipe off the ink on the ink discharge faces F. An applying member that holds the ink 22 discharged on the ink discharge faces F and spreads the ink 22 on the ink discharge face F may be provided instead of the first wipers 35a to 35c. Some examples of this kind of application member include a metal member or synthetic resin member that includes the concave portions 60 to hold ink on the upper end faces (see FIG. 20 and FIG. 29).

It will be appreciated that the disclosure will not be limited to the embodiments described above, but many variations thereof are possible without departing from the spirit of the disclosure. For example, as an ink application process, the above respective embodiments provide a first application process of applying and spreading the ink 22 on the ink discharge faces F of the upstream side from the stop position P of the first wipers 35a to 35c, and a second applying process of applying and spreading the ink 22 on the ink discharge faces F of the downstream side from the stop position P of the first wipers 35a to 35c. However, only the second applying process may be performed by moving the first wipers 35a to 35c from the stop position P to the downstream side only without providing the first applying process.

In this case, mist and paper dust adhered to the ink discharge faces F of the upstream side from the stop position P cannot be removed. However, mist and paper dust or similar adhered to the ink discharge face F of the downstream side from the stop position P can be removed more surely than before because the ink 22 is applied and spread over the whole ink discharge face F of the downstream side from the stop position P.

A conventionally-known other driving mechanism may be used for the driving mechanism of the carriage 31 (the first wipers 35a to 35c), which is constituted of the rack gear 38, the input gear 43, and the elevating mechanism 50. The number of the ink discharge nozzles 18 of the recording heads 17a to 17c and the interval between the nozzles or similar parameter may be set appropriately depending on the specifications of the ink-jet recording apparatus 100. In addition, the number of the recording heads is not specifically limited. For example, one, two, or four or more recording heads 17 for each of the line heads 11C to 11K may be located.

The disclosure may also be applied to an ink-jet recording apparatus for monochromatic printing having only any one of the line heads 11C to 11K. In that case, since one each of the recording heads 17a to 17c is provided, it is only necessary that the first wipers 35a to 35c, which correspond to the recording heads 17a to 17c, are secured to the carriage 31. Effects of the disclosure will be further illustrated by the following examples.

### Working Example 1

When performing the wiping operation with using the wiping mechanism 30 according to the first embodiment, the difference in spreading of the ink 22 is examined in cases for both stopping and not stopping the first wipers 35a to 35c at the stop positions P. A testing machine was prepared. The testing machine includes the carriage 31 that moves to the approaching or separating direction with respect to the ink discharge faces F of the recording heads 17a to 17c as well as reciprocating along the ink discharge faces F and attached rubber blades made of EPDM (Asker hardness 60, impact resilience about 60%) having a width of 30 mm, a height of 7 mm, and a thickness of 1.5 mm as used for the first wipers 35a to 35c.

The recording heads 17a to 17c includes dot forming units with a structure illustrated in FIG. 6. The pressurization chamber 75 has an area of 0.2 mm², a width of 200 μm, and a depth of 100 μm. The nozzle channel 76 has a diameter of 200 μm and a length of 800 μm. The supply hole 79 has a diameter of 30 μm and a length of 40 μm. The ink discharge nozzle 18 has a length of 30 μm. The discharge port 18a has a circular shape with a radius of 10 μm. The recording head where the dot forming units of the above configuration of 166 sets in one row on the ink discharge face F and 664 sets in total (four rows) were located was prepared. The ink discharge nozzles 18 have a pitch of 150 dpi in the same row is, while the pitch as a whole is 600 dpi by shifting one-quarter of pitch neighboring each row.

The ink 22 to be used is a water based ink having a composition composed of the items as described in Table 1. After agitating the respective components, the solution was pressure-filtrated by a filter of pore size of 5 μm to make the ink 22.

TABLE 1

| Materials | Compounded amount [wt %] |
|---|---|
| Pigment dispersion | 25.0 |
| Olefin | 0.5 |
| 1,3-butanediol | 5.0 |
| Triethylene glycol monobutyl ether | 5.0 |
| 2-pyrrolidone | 5.0 |
| Glycerin | 15.0 |
| Ion exchanged water | 47.5 |
| Total | 100.0 |

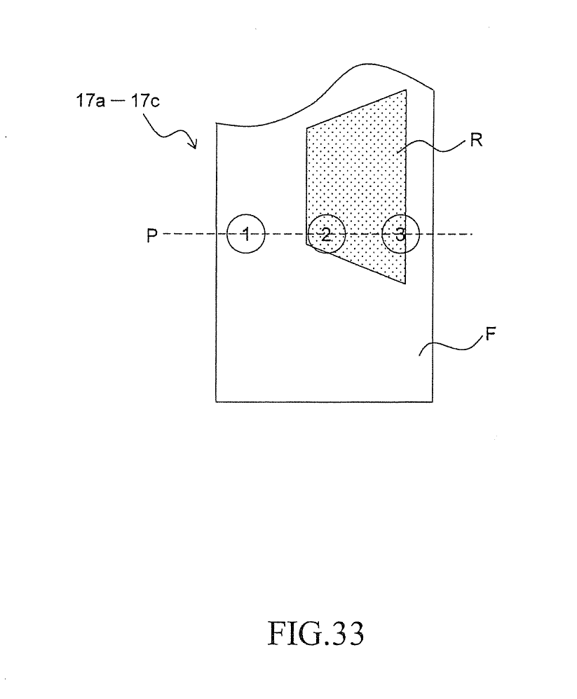

Spreading of the ink 22 on the ink discharge face F was assessed for a case where the first wipers 35a to 35c were stopped for a predetermined duration at the stop position P (Test example 1) and a case where the first wipers 35a to 35c were not stopped (comparison example). As illustrated in FIG. 33, the state of adhesion of the ink to the three locations (marked as 1, 2, 3 from the left) of the width direction on the stop position P (illustrated as a broken line) was visually observed as the assessment method. The results are shown in Table 2.

TABLE 2

| | 1 | 2 | 3 |
|---|---|---|---|
| Comparison example | X | ◯ | ◯ |
| Test example 1 | ◯ | ◯ | ◯ |

As is obvious from Table 2, in comparison example where the first wipers 35a to 35c were not stopped at the stop positions P, the adhesion of the ink at the locations 2 and 3 that are facing the nozzle region R was confirmed. However, the adhesion of the ink was not observed at the location 1 that does not face the nozzle region R. On the other hand, in Test example 1 where the first wipers 35a to 35c were stopped at the stop positions P, adhesion of the ink was confirmed at all the locations 1 to 3.

### Working Example 2

When performing the wiping operation with using the wiping mechanism 30 according to the first embodiment, the relationship between the shape of the upper end faces of the first wipers 35a to 35c and spreading properties of ink were investigated. Using the first wipers 35a to 35c having the similar configuration of the Working Example 1, the time till the ink is filled with between the upper end faces of the first wipers 35a to 35c and the ink discharge faces F after discharging the ink was measured for the following examples: (1) a case where the upper end faces of the first wipers 35a to 35c are flat (Test example 2), (2) a case where rectangular shaped concave portions 60 as illustrated in FIG. 20 are formed (Test example 3), and (3) a case where tapered shape concave portions 60 as illustrated in FIG. 29 are formed (Test example 4). The results are shown in Table 3.

TABLE 3

| | Test example 2 | Test example 3 | Test example 4 |
|---|---|---|---|
| Time till the ink is | 5 | 3 | 2 |
| filled (sec.) | | | |

As is obvious from Table 3, it took five seconds to fill the ink in Test example 2 where the upper end faces of the first wipers 35a to 35c are flat, whereas it took three seconds and two seconds to fill the ink in Test example 3 and 4, respectively, which include the concave portions 60 on the upper end faces. These results confirmed that the time to fill the ink may be shortened by forming the concave portions 60 on the upper end faces of the first wipers 35a to 35c. In addition, the comparison of Test examples 3 and 4 confirmed that the tapered shape where the groove width is gradually widened from the side where the ink contacts are more preferable for the shape of the concave portions 60.

### Working Example 3

When performing the wiping operation with using the wiping mechanism 30 according to the first embodiment, a degree of wiping the mist adhered to the upstream side of the wiping direction from the stop position P was observed in the following cases: (1) a case where the first wipers 35a to 35c moved to the end edge of the downstream side of the wiping direction after moving the first wipers 35a to 35c from the stop position P to the end edge of the upstream side of the wiping direction while holding ink between the upper end faces of the first wipers 35a to 35c and the ink discharge faces F as illustrated in FIG. 22 (Test example 5), and (2) a case where the first wipers 35a to 35c moved from the stop position P to the end edge of the downstream side of the wiping direction without moving the first wipers 35a to 35c to the end edge of the upstream side of the wiping direction (Test example 6). If the mist did not remain, it is marked with a circle “◯”, and if the mist remained, it is marked with a cross “X”. The results are shown in Table 4.

TABLE 4

| | Test example 5 | Test example 6 |
|---|---|---|
| Degree of wiping | ◯ | X |

As is obvious from Table 4, the remaining of mist in the upstream side of the wiping direction from the stop position P was not observed in Test example 5 where the first wipers 35a to 35c was moved to the end edge of the downstream side of the wiping direction after moving the first wipers 35a to 35c from the stop position P to the end edge of the upstream side of the wiping direction. On the other hand, the remaining of mist in the upstream side of the wiping direction from the stop position P was confirmed in Test example 6 where the first wipers 35a to 35c were moved from the stop position P to the end edge of the downstream side of the wiping direction. This results confirmed that the mist adhered to the upstream side of the nozzle region R in the wiping direction can also be effectively removed by moving the first wipers 35a to 35c to the end edge of the downstream side of the wiping direction after moving the first wipers 35a to 35c from the stop position P to the end edge of the upstream side of the wiping direction.

The disclosure is applicable to an ink-jet recording apparatus that performs recording by discharging ink from the recording head. Use of the disclosure ensures an ink-jet recording apparatus with a recovery mechanism that can remove the dried mist and foreign object such as paper dust adhered to the ink discharge face of the recording head more surely and effectively suppress poor ink discharge and reduction in sealability when mounting the cap.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A recovery system for a recording head, comprising:
a recording head that includes a nozzle region where a discharge nozzle has an opening, the nozzle region being configured to discharge ink onto a recording medium;
at least one wiper configured to pressure-contact a wiping start position outside the nozzle region and to wipe an ink discharge face in a predetermined direction, the ink discharge face including the nozzle region;
at least one application member configured to apply and spread ink discharged from the nozzle region over the ink discharge face;
a driving mechanism configured to reciprocate the wiper along the ink discharge face and move the at least one wiper in an approaching or separating direction with respect to the ink discharge face, and
a control unit for controlling the operation of at least the at least one application member and the at least one wiper,
wherein the control unit is configured to stop the at least one application member for a predetermined time at a stop position facing one end of the nozzle region at a predetermined distance from the nozzle region so as to hold the ink discharged from the nozzle region between an upper end face of the at least one application member and a whole region in a width direction of the ink discharge face,
wherein the control unit is configured to move the at least one application member from the stop position along the ink discharge face so as to apply the ink over the ink discharge face while holding the ink between an upper end face of the at least one application member and the ink discharge face, and
wherein the control unit is configured to move the at least one wiper along the ink discharge face so as to wipe off the ink while contacting the ink discharge face over which the ink is applied.

2. The recovery system to claim 1,
wherein the control unit is further configured to move the at least one application member from the stop position in a direction to a first end edge of the ink discharge face as an opposite direction to the nozzle region, and then to move the at least one application member from the first end edge to a direction of a second end edge on another end side of the ink discharge face through the nozzle region, when the at least one application member applies ink over the ink discharge face.

3. The recovery system according to claim 1, further comprising
an ink holding structure configured to hold the ink discharged from the nozzle region on an upper end face of the at least one application member.

4. The recovery system according to claim 3,
wherein the ink holding structure includes a groove shaped concave portion, said concave portion being provided on an upper end face of the at least one application member such as to face the nozzle region, wherein the concave portion is formed along the width direction of the ink discharge face.

5. The recovery system according to claim 3,
wherein the concave portion has a tapered shape with a groove width gradually widened from one end portion toward another end portion along the width direction of the ink discharge face.

6. The recovery system for the recording head according to claim 1,
wherein the at least one wiper and the at least one application member constitute a same member.

7. The recovery system according to claim 1,
wherein a plurality of wipers are provided, said plurality of wipers being arranged on an upstream side of the at least one application member at a predetermined distance in a wiping direction, and
wherein the plurality of wipers and the at least one application member are configured to move in the wiping direction so as to continuously perform application of ink over the ink discharge face and wiping off the ink on the ink discharge face.

8. An ink-jet recording apparatus, comprising
the recovery system for the recording head according to claim 1.

9. A recovery method for a recording head that includes a nozzle region where a discharge nozzle has an opening for discharging ink onto a recording medium, the recovery method comprising the steps of:
stopping an application member for a predetermined time at a stop position facing one end of the nozzle region at a predetermined distance from the nozzle region to hold the ink discharged from the nozzle region between an upper end face of the application member and a whole region in a width direction of an ink discharge face, the application member being configured to apply ink discharged from the nozzle region over the ink discharge face including the nozzle region;
moving the application member from the stop position along the ink discharge face while holding the ink between the upper end face thereof and the ink discharge face; and
moving the wiper along the ink discharge face so as to wipe off the ink while contacting the ink discharge face over which the ink is applied.
